(19) United States
(12) Patent Application Publication
(10) Pub. No.: US 2006/0010183 A1
(43) Pub. Date: Jan. 12, 2006

(54) Random number generation

(75) Inventors: Michael Rabin, Cambridge, MA (US); Woodward Yang, Lexington, MA (US); Hanming Rao, Cambridge, MA (US)

Correspondence Address: FISH & RICHARDSON PC, P.O. BOX 1022, MINNEAPOLIS, MN, 55440-1022, US

(73) Assignee: President and Fellows of Harvard College, Cambridge, MA (US)

(21) Appl. No.: 10/887,713

(22) Filed: Jul. 9, 2004

(51) Int. Cl. G06F 1/02

(52) U.S. Cl. 708/250

(57) ABSTRACT

Sensor elements each of which occupies one of at least two states at a given time, are exposed to an external influence capable of switching a state of at least a random one of the elements. After the exposing has occurred, information identifying the sensor elements, the states of which have been switched, is used to generate random numbers.

### BACKGROUND

This description relates to random number generation.

Random bits and random numbers have many applications. They are employed in cryptographic protocols and for encryption to generate session and encryption keys. Network protocols such as the Ethernet protocol use them to avoid collision of messages. Another application is to so-called Monte Carlo computations. Here a large-scale computation such as the determination of the progress of traffic on a highway, or a complicated chemical diffusion process, is simulated by a stochastic process employing a copious stream of random numbers. Computationally generated so-called pseudo-random numbers, which are sometimes used for these purposes, may follow a pattern that adversely affects their intended use.

Reducing the influence of external factors and biases is important for reliable, high quality random number generation. Typical random number generators are not truly random. They are usually based on a pseudo random number generator (PRNG) function and a random seed. The PRNG is a deterministic function which, given enough information, can be discovered. The random seed is usually not truly random as it is often based on information as simple as a sample of the system clock and internal process ID numbers.

Physical devices are sometimes used to produce a stream of truly random bits and numbers. Thermal noise is sometimes used as source of random numbers, but is sensitive to temperature, can be affected by characteristics of circuit elements, and distorted by other noise sources. Quantum effects and radioactive decay of atomic nuclei have also been used to generate random numbers. For example, U.S. Pat. No. 5,987,483 describes a random number generator that relies on the directional randomness of radioactivity to generate a random sequence of numbers. By truly random numbers, we mean those whose distribution cannot be influenced or predicted by any external measurements or external factors. A truly random number generator produces a sequence of independent numbers with a specified distribution and a specified probability of falling in any given range of values.

Another approach detects the arrival of consecutive alpha particles and compares the time difference of their arrival to generate truly random bits. In another technique, a beam splitter or a polarizing beam splitter directs a single photon toward two different sensors and takes advantage of the randomness of which sensor the photon hits.

### SUMMARY

In general, in one aspect, the invention features a method that includes exposing a large number of sensors simultaneously to an external influence (e.g., a radioactive source) capable of changing the conditions of a large number of random ones of the elements in a short period of time, and based on the changed conditions, generating random numbers at a high rate.

In general, in another aspect, the invention features a method that includes exposing sensor elements each of which occupies one of at least two states at a given time, to an external influence capable of switching a state of at least a random one of the elements. After the exposure to external influences, information identifying the sensor elements, the states of which have been switched, is used to generate random numbers.

Implementations may include one or more of the following features. The information identifying the sensor elements includes information associated respectively with groups of the sensor elements. The sensor elements comprise two-state circuit elements. The sensor elements are part of a memory device. The sensor elements are organized as groups and the information identifying the sensor elements is determined separately with respect to each of the groups. The exposing continues for a set period that is selected so that, during the set period, the states of fewer than a specified number or a specified percentage of the sensor elements in each of the groups have been switched. The information identifying the sensor elements comprises addresses within a memory space. The external influence comprises detectable radiation. The elements are exposed to the external influence for a set period of time. The information identifying the sensor elements is provided by a process initiated by the sensor elements, the states of which have been switched.

In general, in another aspect, the invention features a method comprising exposing binary cells of at least one random access device to radiation capable of switching a state of least a random one of the elements, and after the exposing has occurred, combining addresses of the cells the states of which have been switched, to generate a random number.

Implementations of this aspect of the invention may include one or more of the following features. The memory cells are organized in groups and the addresses are defined separately with respect to each of the groups. The exposing continues for a set period that is selected so that, during the set period, the states of fewer than a specified number or a specified percentage of the memory cells in each of the groups have been switched.

In general, in another aspect, the invention features a method for enhancing the randomness of generated random numbers by combining according to a specified rule the outputs of several random number generating devices into one stream of random numbers.

In general, in another aspect, the invention features a method for enhancing the randomness of generated random numbers by combining according to a specified rule a multiplicity of multiple streams of random numbers produced by one device into one stream of random numbers.

In general, in another aspect, the invention features an apparatus that includes (a) sensor elements each of which occupies one of at least two states at a given time, (b) a source of an external influence to switch a state of at least a random one of the elements, and (c) a processor to use information identifying the sensor elements the states of which have been switched, to generate random numbers.

Implementations may include one or more of the following features. The source includes a source of radiation. The external influence includes alpha particles. The sensor elements are part of a memory device. The source is less than 4 mm away from the elements in air. The sensor elements are arranged in a two-dimensional array and the source includes a two-dimensional element that is proximate to the array. The elements are organized in groups, and the processor operates separately with respect to the information identifying the sensor elements in the respective groups. Each of the sensor elements is configured to provide information about its identity when its state is switched. Among the advantages of the invention are that it can generate more than 100 M/s of random numbers per chip with strong randomness characteristics.

In general, in another aspect, the invention features an apparatus comprising (a) groups of sensor elements each of which occupies one of at least two states at a given time, (b) a source of an external influence to switch a state of at least a random one of the elements in each of at least one of the groups, and (c) a processor to use information that is associated with the sensor elements of each of the groups, the states of which have been switched, to generate random numbers, the processor using the information for each of the groups separately.

Implementations of the invention may include one or more of the following features. The source comprises a source of radiation. The external influence comprises alpha particles. The sensor elements are part of a memory device. The sensor elements are arranged in a two-dimensional array and the source comprises a two dimensional element that is proximate to the array. Each of the sensor elements is configured to provide information about its identity when its state is switched.

In general, in another aspect, the invention features an apparatus comprising sensor elements each of which occupies one of at least two states at a given time and is configured to provide information about its identity when its state has been switched by an external influence that causes random ones of the elements to switch states.

Light (photons) may also be used as an external influence to produce random events as the basis for random number generation.

Other features and advantages will be apparent from the description and claims.

### DESCRIPTION

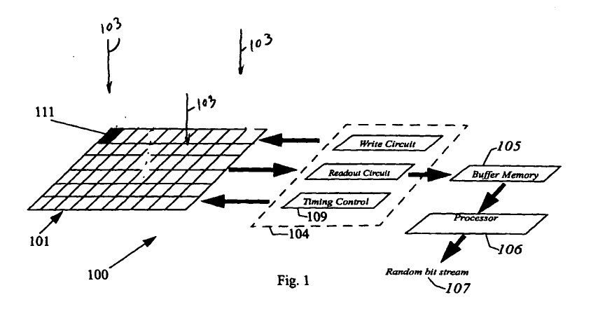

FIG. 1 is a schematic view of a device.

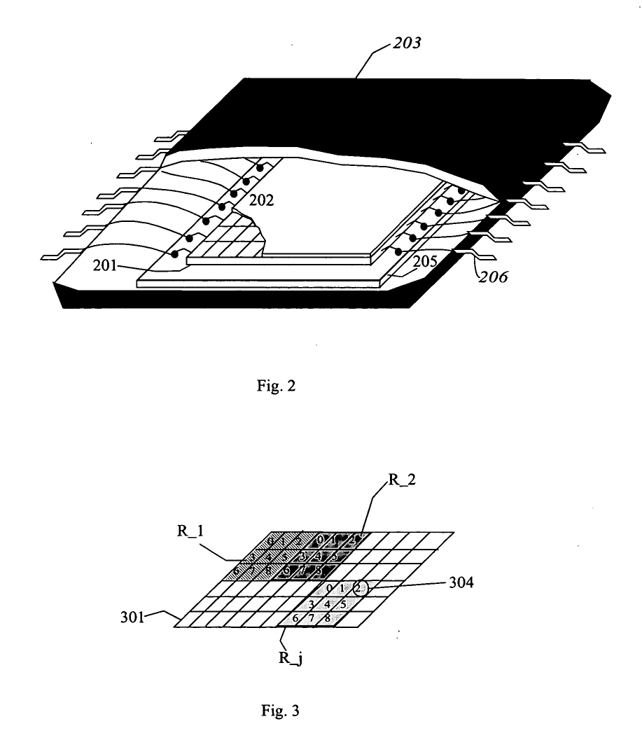

FIG. 2 is a perspective view of a device.

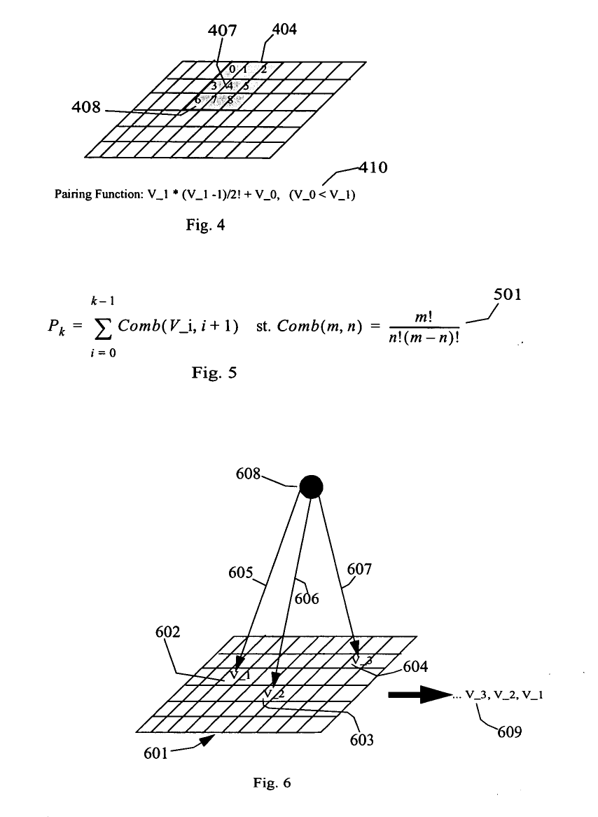

FIGS. 3 and 4 are schematic views of sensor arrays partitioned into regions.

FIG. 5 shows an equation.

FIG. 6 is a schematic view of a device.

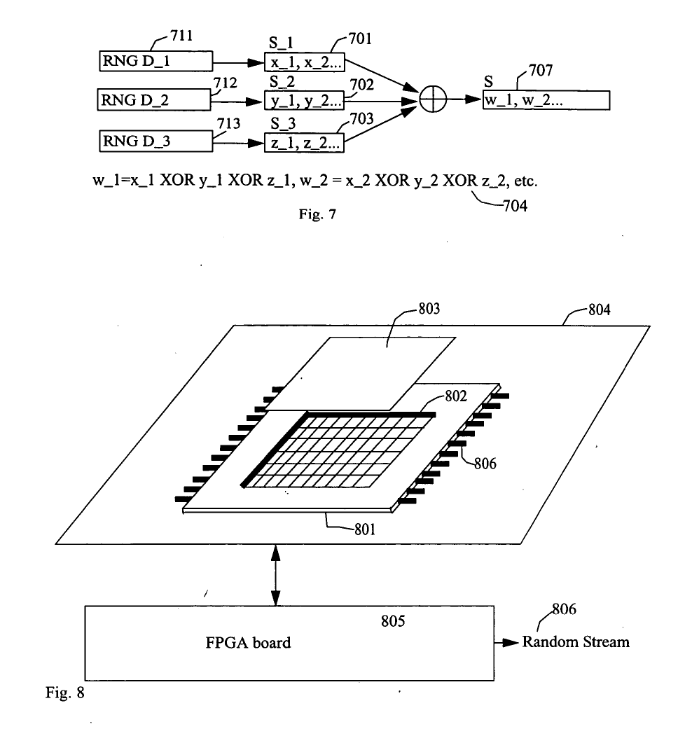

FIG. 7 is a block diagram.

FIG. 8 is a schematic view of a random number generator.

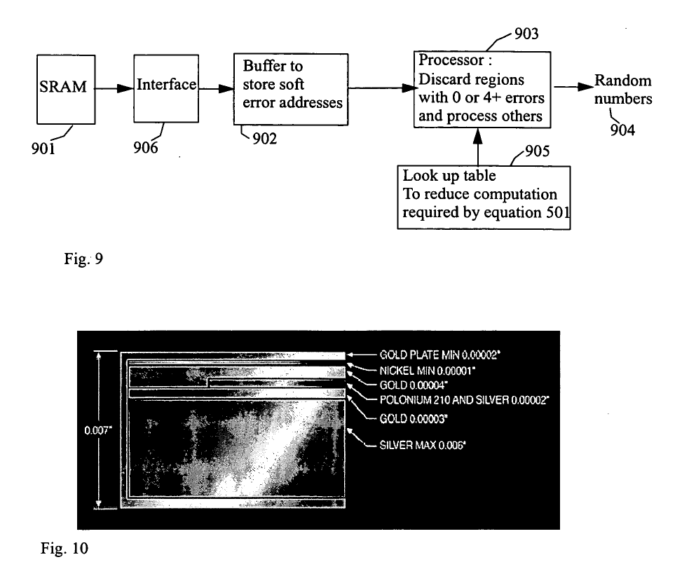

FIG. 9 is a system architecture.

FIG. 10 is a top view of a source.

In some implementations of the techniques described here, sensors are permitted to change state under the influence of ionizing radiation provided from a source over a period of time. A circuit reads out the addresses (which represent the identities) of sensors that have changed state as result of the radiation. A stream of random bits and numbers is derived from the addresses according to specified rules. When the radiation source and sensors exhibit appropriate physical properties of randomness, the resulting stream of bits or numbers will be truly random.

This approach is based on the notion that radioactive decay of nuclei (and the resulting ionizing radiation) occurs according to the physical laws of quantum mechanics and is unpredictable. Radioactive decay of nuclei sometimes results in ionizing radiation such as high-energy alpha particles. Some implementations use Po-210, which gives off 5.3 MeV high-energy alpha particles. However, other elements and isotopes could also be used. The specific nuclei within a given mass of an isotope that will decay within a given time interval are completely random. Yet a large ensemble of nuclei exhibits well-known, specific statistical characteristics such as an expected number of radioactive nuclei decay events per unit time.

One type of sensor element (which we will call a simple sensor) has a ready state (in which it is capable of detecting a particle), a detection state (in which it has detected, for example, an alpha particle), and a reset state (in which it has been reset but has not yet entered the ready state). Another type of sensor element (which we will call a two-state sensor) has two (or more) sensing regions. The state of the two-state sensor changes depending on which region detected the most recent ionizing radiation. One specific example of a two-state sensor is a 6 transistor SRAM cell implemented using silicon integrated circuit technology, though other sensors could be used.

Implementations of a truly random number generator may include the following (although there are many other possible ways to implement the concept).

1. A flux of ionizing radiation is applied to a two-state sensor. The state of the sensor element is random after being subjected to the flux of ionizing radiation. The process is repeated in a sequence of cycles and the sequence of states of the sensor after the respective cycles is random and is used to extract a truly random number.

2. A flux of ionizing radiation is applied to an array of sensors and the truly random numbers are generated based on the locations of single distinct ionizing radiation events. This permits the generation of multiple random bits per ionizing radiation event.

One implementation approach would use sensors that have equal probabilities of detecting ionizing radiation. A stream of random numbers is extracted based on the sequence of sensors that detect ionizing radiation. The information about which sensor has detected ionizing radiation can be obtained by arranging for each of the sensors to “scream” when it detects radiation. A chip could bear an array of such sensors and be called a SCREAMER chip. Other implementations would also be possible.

Equal probability of detecting radiation can be achieved using a point ionizing radiation source and sensors that have equal cross-sectional areas exposed to the source. Equal probability can also be achieved by depositing equally active amounts of radioactive material on identical sensors. There are many other possible methods of making sensors having equal probabilities of detecting radiation, such as planetary rotational systems.

A random number can be generated by assigning a unique address (i.e., an ID number) to each sensor (e.g., 000, 001, 010, 011, 100, 101, 110, 111 for eight sensors). Then a random bit stream can be constructed by concatenating the 3-bit binary IDs of the sequence of sensors that detect radiation. In general, if there are N sensors and n events are sequentially detected then a stream of n times log_{—}2(N) random bits is generated.

If simultaneous ionizing radiation events occur (that is, simultaneous within the limits of the speed of sensor detection and reset to the ready state), the system ignores the duplicate events.

The efficiency of generating random bits per radiation event grows as the number of sensors increases (because of improved spatial resolution in detecting radiation and the fact that the address IDs for the sensor are longer), however, more sensors produce more likely simultaneous events.

Another approach to dealing with simultaneous events uses an appropriate function that uniquely numbers all possible pairs (or triplets or quadruplets or n-tuplets) of sensor IDs (addresses). Then a stream of random bits can be generated by concatenating the outputs of the addresses (for single events) and the appropriate function values based on pairs, triplets . . . n-tuplets of addresses of simultaneous multiple hits.

Other implementations use two-state sensors by arranging to start the sensors in a known state for each detection cycle. Detection of ionizing radiation is determined to have occurred if the state of the two-state sensor at the end of the set time is different than the initialized state. SRAM sensors, for example, usually will have lower sensitivity to ionizing radiation compared to simple type sensors but may have a simpler read and reset mechanism.

Turning to implementations that use SRAM chips, for example, each memory cell within each chip would constitute a sensor within the array. When an alpha particle strikes near or on a memory cell, the content of the cell may flip from a 0 to a 1, or vice-versa, causing a so-called soft error.

In some implementations, each SRAM cell has a symmetric architecture, contains two inverters in a loop, and has only two stable states that correspond to bits of value 0 and value 1. When the supply voltage to the SRAM is kept low, each cell is more vulnerable to soft errors. For this reason, the supply voltage may be kept at higher levels when the SRAM is being written to or read from, and at lower levels during radiation.

When alpha particles strike the silicon of an SRAM, for example, many electron-hole pairs are created. When the number of those electron-hole pairs is large enough, they cause the state of the associated logic gate (SRAM cell) to flip, changing the stored value. Depending on where in the SRAM cell the particle hits, the stored bit is either set or reset. The flipping is called a soft error, because it does not permanently damage the SRAM cell. Because radioactive decay of each atom of the source layer is a random event, the occurrence of the soft errors will also be random.

The rate at which source particles are produced (which depends on the selection and design of the source) and the rate of bit flips per cell are both related to the desired random rate of bits to be generated. In one example, the source is 0.8 mCi (1 Ci=37B alpha particles per second), and the SRAM stores 8 Mb of data. In the example, about 1% to 5% of the cells of the SRAM flip for every second of radiation to which the SRAM is exposed, based on certain conditions, for example, when the distance from the source to the SRAM is 1 mm and the supply voltage to the SRAM is held at the minimum necessary to retain the data in the absence of radiation. There exist a variety of other configurations of source and SRAM that would also work.

The memory chip may be initialized to have all its memory cells store the value 0, or all 1. In other examples, certain predetermined regions or cells of the memory chip are initialized to 0, while others are initialized to 1.

When a set period of exposure is used, at the end of the time period of exposure to the radioactive particles, some of the memory cells will have had their bits flipped from 1 (assuming all of the cells were initialized to 1) to 0. A given memory cell may have its content flipped more than once back and forth between 1 and 0 during the period. But this does not affect the random nature of the process.

In some implementations, at the end of the time period, the bits stored in the memory chip are read out and recorded in a memory that is uninfluenced by detectable radiation. That second memory will then contain a long sequence of bits, for example, 8 to 32 megabits for currently available SRAMs or 256 megabits for currently available DRAMs.

In other examples, it is the addresses of the memory cells that, as of the end of the period, had been flipped to the value 0 that are read out and stored in the memory not subject to radiation.

After the readout has occurred, all of the memory cells of the first memory chip are initialized again, for example, to 1 (or to 0), and the process is repeated for another set time period (which may be called a detection cycle). This enables the generation of random bits or numbers on a continuing basis.

As explained earlier, the emission of a particle or high-energy radiation from a given atom of radioactive material within a set time interval is a random event. (Also, whether or not a cell that receives a particle has its bit flipped is itself a random process. Consequently, the flipping or non-flipping of a given memory cell on the chip within the set time interval is a physically random event.

Thus, at the end of the period, the values 0 are found at random locations within the stored output sequence of 1 and 0 bits, and a sequence of truly random bits can be extracted from the output sequence. The addresses of the memory cells of the irradiated chip that flipped to 0 also possess randomness properties from which a stream of random bits or numbers can be derived.

The radioactive source used in some implementations is weak and is encapsulated (together with the radiated memory chip) in an appropriate shield, to remove any danger to users or the environment.

In some implementations, the memory chip is logically or physically partitioned into m regions R_1, . . . , R_m. Physical partitioning may sometimes be preferable in allowing faster read-out of the data. Depending on the flux of detectable radiation incident on the chip within the set time period and the resulting number of memory cells that end the period having been flipped from 1 to 0, the number of cells within each region that is likely to have been flipped from 1 to 0 as of the end of the period is small, say, between zero and four for a particular region. If each region were to have 1024 memory cells, for example, each cell will be logically addressed by an integer from 0 to 1023, represented as a 10-bit binary number.

Partitioning the chip into regions has advantages. The uniformity of radiation received by each of the regions will be higher than the uniformity across the entire chip and consequently the locations of hits will be uniformly random. Also, less computation is required to process the information from each of the regions and extract random numbers than from the whole chip at once. In general, the computation required to extract randomness from addresses of a region in which soft errors have occurred increases with the number of said soft errors. One goal in designing the system and choosing the sizes of regions is to have an average of up to 3 to 4 soft errors per region per time period. However, other values would also be possible.

If, as of the end of the time interval, a particular region R_j has exactly a single cell, at address v_o, containing a bit that had been flipped from 1 to 0, the 10 bits of the integer v_0 written in binary notation comprise random bits produced by the flipping of that bit.

If exactly two cells, having addresses v_0 and v_1, where v_0<v_1, were flipped from 1 to 0, then a pairing function P_1(v_0, v_1) may be used to extract random bits from this event (of flipping of exactly two bits at those two addresses). In some implementations, where the region comprises 1024 cells, the pairing function P_1 would be one that maps all such pairs of integers (v_0, v_1) in a one-to-one manner onto integers u=P_1(v_0, v_1) comprising the interval of integers from 0 to 532775, thus producing about 19 random bits in the binary representation of the integer u. An example of such a pairing function is shown in FIG. 4.

Similarly, if exactly three cells, having addresses v_0, v_1, and v_2, where v_0<v_1<v_2, were flipped from 1 to 0, then a pairing function P_2(v_0, v_1, v_2) is used to extract random bits. In some implementations, in which the region comprises 1024 cells, the pairing function P_2 maps all such triplets of integers (v_0, V_1, v_2) in a one-to-one manner onto integers u=P_2(v_0, v_1, v_2) comprising the interval of integers from 0 to 17843301, thus producing about 27 random bits in the binary representation of the integer u. The case of four cells within a region having been flipped from 1 to 0 is similarly dealt with using another pairing function P_3(v_0, v_1, v_2, v_3). And so on.

In other implementations, a modified memory chip, which we call a SCREAMER (as a mnemonic for the notion that it “screams”: “I have been flipped!”) memory chip, could be used. In a SCREAMER memory chip, every memory cell has electronic circuitry that causes the cell to read out its own address immediately upon flipping from 1 to 0 (or 0 to 1, depending on how the chip is initialized) by an impact of a radiation particle.

One example of a SCREAMER chip could have 32 million memory cells each storing a bit. The address of each such cell is represented by an integer written as 25 bits in binary notation. During the set time period, about 3 million cells will have flipped from 1 to 0. Let the addresses of the said flipped cells be v_1, v_2, . . . , v_3,000,000, where v_1 is the address of the first cell to flip, v_2 is the address of the second cell to flip, etc. Now the sequence v_1ˆ v_2ˆ, . . . ,ˆ v_3000000, where ˆ denotes concatenation (for example, 10010ˆ01101=1001001101), is a sequence of 75 million random bits produced by the SCREAMER memory chip within the set time period.

The random nature of the bits produced by these techniques can be further enhanced by combining the outputs of several randomness generating chips.

For example, suppose several separate devices, say three devices D_1, D_2, D_3, are used to generate random bits. If D_1 produces the sequence of random bits x_1, x_2, . . . , D_2 produces the random bits y_1, y_2, . . . , and D_3 produces z_1, z_2, . . . , then these bits may be combined to produce random bits w_1=x_1XOR y_1XOR z_1, w_2=x_2XOR y_2XOR z_2, etc. Here XOR is the operation such that for bits, 0XORx=xXOR0=x, and 1XOR1=0. It can be mathematically proven that this combination of the outputs of several randomness sources produces very pure random bits.

In other implementations, several output sequences from the same chip or from different regions of the same chip or several chips are combined in the above manner to produce very pure random bits.

FIG. 1 conceptually shows a device 100 having an array 101 of sensor units 111, and ionizing radiation 103 impacting the array. A readout circuit 104 reads out addresses of sensors that store bits that have been flipped by the radiation. A timing device 109 sets a time interval. Upon termination of the time interval, data is read out from the array by the readout circuit 110. A buffer memory 105, which is not under radiation, records the addresses read out of the array, and a processor 106 melds the addresses into a stream 107 of random bits or numbers. When the addresses have been read out, a write circuit initializes the array 101 in preparation for the next cycle.

In a specific example, shown in FIG. 2, an array and a source are implemented as a memory chip 201 coated or covered by a thin layer or plate 202 of alpha particle emitting radioactive material. The ensemble is encapsulated by a coating of radiation shielding material 203. The chip is mounted on a substrate 205 and leads 206 provide electrical access from the outside world. A wide variety of other implementations are also possible.

FIG. 3 shows an array 301 of sensors partitioned into regions R_1, . . . , R_m, and a region R_j, 303. Each region is an N by N (e.g., nine by nine) array of sensors 304 addressed by integers v, where 0<=v<Nˆ2.

FIG. 4 shows a region 404 which absorbs two instances of detectable radiation that caused sensors 407 and 408 with addresses v_0<v_1 to change state. A pairing function 410 is used to compute an integer u from the pair v_0<v_1.

FIG. 5 shows a particular function P_k 501 used to combine k addresses 502 of k locations v_0<v_1, . . . , <v_(k−1) into a single integer u:
u=P_{—}k(v_0, v_1, . . . , v_(k−1))

FIG. 6 shows an example of a SCREAMER chip 601. Sensors 602, 603, 604 were hit by alpha particles or other detectable radiation 605, 606, 607 emitted sequentially in that order from a radiation source 608. The chip outputs the addresses 609 of those sensors in the same sequence.

FIG. 7 shows how streams s_1=x_1, x_2, . . . , 701, s_2=y_1, y_2, . . . , 702, s_3=z_1, z_2, . . . , 703, of random output bits of multiple devices D_1, 711, D_2, 712, D_3, 713, are combined into one stream s=w_1, w_2, . . . , 707 according to the rule 704: w_1=x_1XOR y_1XOR z_1, w_2=x_2XOR y_2XOR z_2, etc.

FIG. 8 shows a specific implementation including an 8 MB SRAM 801 as the sensor. A plastic layer on top of the chip (not shown) has been carefully peeled off. The upper surface of the SRAM die 802 is exposed for radiation from a radiation source 803 that is in the form of a flat rectangular plate having essentially the same length and width as the SRAM. The source is a sealed 0.8 mCi Po-210 source (available from Isotopeproducts, Inc.). Each time a Po-210 nucleus disintegrates, it emits one alpha particle with 5.3 Mev energy. Since these alpha particles can travel only about 40 mm in the air, the source and the SRAM die are put close to each other. This source produces about 37 billion alpha particles per second. The vertical distance from the radiation source to the SRAM die is about 1 mm in this example. An SRAM interface board 804 is used to connect pins 806 of the SRAM to a Xilinx FPGA board 805 for read/write control and processing of the data. A stream of random bits 806 is generated by the Xilix FPGA board. Many other implementation are possible using a wide variety of hardware, software, and computational regimes.

The source can be selected based on the rate of random soft errors that is desired and the sensitivity of the SRAM to exhibit soft errors when alpha particles hit it. In one specific example, the source may be very thin, about 0.007″, but the thickness is likely not a critical parameter. The configuration of this specific example of the source is shown in FIG. 10. Although the example described above uses Po210 as the radiation source, a wide variety of other sources, such as Am241, would also work.

FIG. 9 shows an example system architecture. A buffer 902 is used to store the addresses in one or more SRAMs 901 at which soft errors have occurred. The address information passes through an interface 906. A processor 903 then processes the address data from regions of the SRAMs in which 1 to 4 errors occurred and produces a stream of truly random numbers (904). A look-up table 905 stores values of Comb (v_i, i+1) save time for the processor in the computation of equation 501.

The interface performs several functions. It initializes the SRAMs by setting the correct voltages: a higher one for read and write operations, and a lower one for radiation operation. The interface manages reading and writing of data in the SRAMs. The interface also provides timing and control signals. The interface accepts the data output by the SRAMs, applies the XORing to find the soft errors, and stores them in a buffer. When multiple SRAMs are used, the interface manages the interaction.

The block buffer stores the soft error addresses that have occurred within a block (i.e., a region of one of the SRAMs) into register files. A count is made by the processor 903 of the number of soft errors in each block to determine whether the data for that block will be used (the block is discarded if the errors are 0 or more than 4, in one example)

The process of generating the random numbers proceeds as follows. The error locations are read from the block buffer. An intermediate result is read from the look-up table. The intermediate results are added together. The random bits are then generated. Finally, the generated random numbers are stored or transmitted for use in an application.

In one implementation, the 8 Mb SRAM has a 70 ns read/write access time. The process first sets all SRAM cells to either a 0 or 1 in a write phase with normal supply voltage, which takes roughly 40 ms. Then the cells are exposed to radiation for 200 ms. Then the data is read out and compared with the pattern we wrote earlier to detect soft errors. Suppose the memory space is N=2ⁿ and we found M(2ⁿ>Aₘ₋₁>Aₘ₋₂> . . . A₀≧0) soft errors at M random locations. The total combination of this random event represented by (Aₘ₋₁, Aₘ₋₂ . . . A₀) is

$${C}_{M}^{N} = \frac{N ( N - 1 ) … ( N - M + 1 )}{M !} \qquad ( 1 )$$

We can convert it to a random number R(0≦R<C_{M}^{N}) by mapping each of the combination to a unique number with the following equation:
R=C_{M}^{A}^{_{m−1}}+C_{M-1}^{A}^{_{m−2}}+ . . . C₁^{A}^{₀} (2)

The computation required is large when both N and M are very large. To make it more practical, as explained earlier, the SRAM is divided into many smaller blocks with size B=2^{b}. Each block will only have an average of 3-4 soft errors during radiation phase. Dividing the SRAM in smaller blocks also helps to reduce the non-uniformity effect of the random source. In this case, for each block there may be 0, 1, 2, 3, 4 or more soft errors. If there is no soft error, there is no random information and the block will be discarded. In some implementations, if there are more than 4 soft errors, the computation is quite complex and the block may be discarded as well. For 1-4 errors, equation 2 is used to produce random numbers.

The optimum value for the block size is based on the distribution of soft errors per block. This can be seen as an occupancy problem: there are l=N/B blocks and total M soft errors uniformly distributed, how many blocks will have k soft errors. It can be solved with recursively. When there are total M−1 soft errors, let F(M−1,k) be the expected number of blocks with k soft errors, F(M−1,k−1) be the expected number of blocks with k−1 soft errors. When the last error happens in blocks with k soft errors, that block will have k+1 soft errors. Thus the total number of blocks with k soft errors will decrease by one. Similarly, the total number of blocks with k soft errors will increase by one if the last error occurs in blocks with k−1 soft errors. The follow equation describes the recursive relation:
F(M, k)=F(M−1,k)−F(M−1,k)/l+F(M−1,k−1)/l (3)
We need boundary condition to derive a close form solution. It is easy to calculate that expected number of blocks with no errors will be:
F(M,0)=l·(1−1/l)^{M} (4)
and expected number of blocks with M errors (all errors happened in one block) will be
F(M,M)=l/l^{M-1} (5)
With (3), (4), (5), a close form solution can be derived below:
F(M,k)=Cₖ^{M}(1−1/l)^{M-k}/l^{k-1} (6)

With an ability to process 1-4 soft errors, by using (6) we know that less than 10% of the blocks will be discarded and less than 10% of the information will be lost.

The throughput of the example described earlier is estimated to be 3 Mbps. With a stronger source, the output of random bits could be hundreds of Mbps for each chip. If the process unit is placed on the SRAM chip, the throughput will be much higher.

Other embodiments are within the scope of the following claims.

For example, other radiation phenomena can be used, such as neutrons, and physical phenomena other than radiation (for example, light, noise, and quantum effects) may also be useful. Other sensor devices may be used.

1. A method comprising
exposing sensor elements each of which occupies one of at least two states at a given time, to an external influence capable of switching a state of at least a random one of the elements, and
after the exposing has occurred, using information identifying the sensor elements, the states of which have been switched, to generate random numbers.

2. The method of claim 1 in which the information identifying the sensor elements includes information associated respectively with groups of the sensor elements.

3. The method of claim 1 in which the sensor elements comprise two-state circuit elements.

4. The method of claim 1 in which the sensor elements are part of a memory device.

5. The method of claim 4 in which the sensor elements are organized as groups and the information identifying the switched sensor elements is determined separately with respect to each of the groups.

6. The method of claim 1 in which the information identifying at least some of the sensor elements, the states of which have been switched, is combined to generate random numbers.

7. The method of claim 5 in which the exposing continues for a set period that is selected so that, during the set period, the states of fewer than a specified number or a specified percentage of the sensor elements in each of the groups have been switched.

8. The method of claim 1 in which the information identifying the sensor elements comprises addresses within a memory device.

9. The method of claim 1 in which the external influence comprises detectable radiation.

10. The method of claim 1 in which the external influence comprises light.

11. The method of claim 1 in which the elements are exposed to the external influence for a set period of time.

12. The method of claim 1 in which the information identifying the sensor elements is provided by a process initiated by the sensor elements, the states of which have been switched.

13. A method comprising
exposing binary cells of at least one random access device to radiation capable of switching a state of least a random one of the elements, and
after the exposing has occurred, combining addresses of the cells the states of which have been switched, to generate a random number.

14. The method of claim 13 in which the memory cells are organized in groups and the addresses are defined separately with respect to each of the groups.

15. The method of claim 13 in which the exposing continues for a set period that is selected so that, during the set period, the states of fewer than a specified number or a specified percentage of the memory cells in each of the groups have been switched.

16. A method for enhancing the randomness of generated random numbers by combining according to a specified rule the outputs of several random number generating devices into one stream of random numbers.

17. A method for enhancing the randomness of generated random numbers by combining according to a specified rule multiple streams of random numbers produced by one device into one stream of random numbers.

18. An apparatus comprising
sensor elements each of which occupies one of at least two states at a given time,
a source of an external influence to switch a state of at least a random one of the elements, and
a processor to use information identifying the sensor elements the states of which have been switched, to generate random numbers.

19. The apparatus of claim 18 in which the source comprises a source of radiation.

20. The apparatus of claim 18 in which the external influence comprises alpha particles.

21. The apparatus of claim 18 in which the external influence comprises light particles.

22. The apparatus of claim 18 in which the sensor elements are part of a memory device.

23. The apparatus of claim 18 in which the sensor elements are arranged in a two-dimensional array and the source comprises a two-dimensional element that is proximate to the array.

24. The apparatus of claim 18 in which the elements are organized in groups, and the processor operates separately with respect to the information identifying the sensor elements in the respective groups.

25. The apparatus of claim 18 in which each of the sensor elements is configured to provide information about its identity when its state is switched.

26. An apparatus comprising
groups of sensor elements each of which occupies one of at least two states at a given time,
a source of an external influence to switch a state of at least a random one of the elements in each of at least one of the groups, and
a processor to use information that is associated with the sensor elements of each of the groups, the states of which have been switched, to generate random numbers, the processor using the information for each of the groups separately.

27. The apparatus of claim 26 in which the source comprises a source of radiation.

28. The apparatus of claim 26 in which the external influence comprises alpha particles.

29. The apparatus of claim 26 in which the sensor elements are part of a memory device.

30. The apparatus of claim 26 in which the sensor elements are arranged in a two-dimensional array and the source comprises a two dimensional element that is proximate to the array.

31. The apparatus of claim 18 in which each of the sensor elements is configured to provide information about its identity when its state is switched.

32. An apparatus comprising
sensor elements each of which occupies one of at least two states at a given time and is configured to provide information about its identity when its state has been switched by an external influence that causes random ones of the elements to switch states.

33. The apparatus of claim 32 in which the sensor elements comprise memory cells and are part of an integrated circuit.

34. The apparatus of claim 32 in which the identity information is provided as an electrical signal.

35. The apparatus of claim 32 in which the providing of the identity information is initiated by the sensor element.

36. The apparatus of claim 32 in which the sensor elements are organized in groups and arranged to be susceptible respectively to separate sources of an external influence capable of switching the states of random ones of the sensors in each group.

37. A method comprising
exposing a large number of sensors simultaneously to an external influence capable of changing the conditions of a large number of random ones of the elements in a short period of time, and
based on the changed conditions, generating a high rate of random numbers.
